(19) United States
(12) Patent Application Publication
(10) Pub. No.: US 2016/0020014 A1
(43) Pub. Date: Jan. 21, 2016

(54) LAMINATED COIL COMPONENT AND METHOD FOR MANUFACTURING IT

(71) Applicant: MURATA MANUFACTURING CO., LTD., Kyoto (JP)

(72) Inventors: Shoichiro FURUKAWA, Nagaokakyo-shi (JP); Takahiro SUMI, Nagaokakyo-shi (JP); Sumiyo NAKAMURA, Nagaokakyo-shi (JP)

(73) Assignee: MURATA MANUFACTURING CO., LTD., Kyoto (JP)

(21) Appl. No.: 14/789,555

(22) Filed: Jul. 1, 2015

(30) Foreign Application Priority Data
Jul. 18, 2014 (JP) 2014-147809

(51) Int. Cl. H01F 27/28; H01F 41/04; H01F 1/16; H01F 27/245

(52) U.S. Cl. CPC H01F 27/2804; H01F 27/245; H01F 41/041; H01F 1/16; H01F 2027/2809

(57) ABSTRACT

A laminated coil component has a laminated body which is formed by laminating a plurality of ferrite layers, a helical coil which is provided in the laminated body, and a plurality of external electrodes which are provided on the surface of the laminated body and are electrically connected to the helical coil and are mainly composed of Cu. The ferrite layers have an exposed region exposed from the surface of the laminated body without being covered with the external electrodes. A surface resistivity of the exposed region of the ferrite layers is more than 10⁴Ω and less than 10⁷Ω.

### CROSS REFERENCE TO RELATED APPLICATIONS

This application claims benefit of priority to Japanese Patent Application No. 2014-147809 filed Jul. 18, 2014, the entire content of which is incorporated herein by reference.

### TECHNICAL FIELD

The present disclosure relates to a laminated coil component and a method for manufacturing it.

### BACKGROUND

Conventionally, there has been an laminated coil component described in WO2011/108701. The laminated coil component has a laminated body which is formed by laminating a plurality of ferrite layers, a helical coil which is provided in the laminated body, and a plurality of external electrodes which are provided on the surface of the laminated body and are electrically connected to the helical coil. The external electrodes are mainly composed of Ag.

### SUMMARY

In the conventional laminated coil component, the external electrodes are mainly composed of Ag, so an external electrode mainly composed of Cu has not been focused upon.

The inventors of the disclosure have focused on an external electrode mainly composed of Cu to solve the following first and second problems in forming the external electrode on the laminated body by firing.

First, when the external electrode mainly composed of Cu is fired on the surface of the laminated body at an equilibrium oxygen partial pressure of Cu—Cu₂O or less, the ferrite layers of the laminated body is reduced, so the resistance of the ferrite layers is decreased. When the ferrite layers have a region exposed from the surface of the laminated body without covering by the external electrode, a metal film is deposited on the exposed region of the ferrite layers by plating a metal film on the external electrode.

Second, when the external electrode mainly composed of Cu is fired on the surface of the laminated body in an air atmosphere, the external electrode is oxidized, so the resistance of the ferrite layer of the laminated body is increased. Therefore, this prevents an electrical connectivity between the external electrode and the helical coil from being good.

Accordingly, an object of the present disclosure is to provide a laminated coil component and a method for manufacturing it, which prevent a metal film from being deposited on the ferrite layers of the laminated body and allows an electrical connectivity between the external electrode and the helical coil to be good.

In order to accomplish the above object, there is provided, a laminated coil component comprising:

a laminated body which is formed by laminating a plurality of ferrite layers;

a helical coil which is provided in the laminated body so as to be partially exposed from a surface of the laminated body; and

a plurality of external electrodes which are provided on the surface of the laminated body and are electrically connected to a part of the helical coil and are mainly composed of Cu,

wherein:

the ferrite layers have an exposed region exposed from the surface of the laminated body without being covered with the external electrodes,

a surface resistivity of the exposed region of the ferrite layers is more than 10⁴Ω and less than 10⁷Ω.

According to the laminated coil component, the ferrite layers have a region exposed from the surface of the laminated body without being covered with the external electrodes, the surface resistivity of the exposed region of the ferrite layers is more than 10⁴Ω and less than 10⁷Ω.

This prevents a metal film from being deposited on the exposed region of the ferrite layers in plating the metal film on the external electrode. This allows an electrical connectivity between the external electrode and the helical coil to be good.
In an embodiment of the laminated coil component, the helical coil is mainly composed of Ag.

According to the embodiment, the helical coil is mainly composed of Ag. This allows a direct-current resistance value (Rdc) of the helical coil to be reduced.
In an embodiment of the laminated coil component, the helical coil is mainly composed of Cu.

According to the embodiment, the helical coil is mainly composed of Cu. This allows a cost of the helical coil to be reduced.
In an embodiment of the laminated coil component, the ferrite layers include at least one of Fe, Mn, Ni and Zn.

According to the embodiment, the ferrite layers include at least one of Fe, Mn, Ni and Zn. This increases a reduction resistance of the ferrite layers to prevent a metal film from being deposited on the ferrite layers.

In an embodiment of a method for manufacturing a laminated coil component,

the method comprising:

a step of providing a helical coil in a laminated body which is formed by laminating a plurality of ferrite layers so as to be partially exposed from a surface of the laminated body;

a step of forming an unfired external electrode film on the surface of the laminated body by coating an external electrode paste mainly composed of Cu to the surface of the laminated body, so that the ferrite layers have an exposed region exposed from the surface of the laminated body without being covered with the external electrode paste; and

a step of forming a plurality of external electrodes which are electrically connected to a part of the helical coil and are mainly composed of Cu, by firing the unfired external electrode film,

wherein:

in the step of forming the unfired external electrode film, an oxygen partial pressure P at 800° C. or more satisfies the following equation:

ln(equilibrium oxygen partial pressure of Cu—Cu₂O)<ln(P)≦ln(4×10⁻¹¹T²−8×10⁻⁸T+5×10⁻⁵),

ln(equilibrium oxygen partial pressure of Cu—Cu₂O)=(−338904−32.80256 log T+246.856T)/RT,

T: temperature[K],
R: gas constant (8.314[J·K⁻¹·mol⁻¹]).

According to the method, in the step of forming the unfired external electrode film, the oxygen partial pressure P at 800° C. or more satisfies the following equation:

ln(equilibrium oxygen partial pressure of Cu—Cu₂O)<ln(P)≦ln(4×10⁻¹¹T²−8×10⁻⁸T+5×10⁻⁵),

ln(equilibrium oxygen partial pressure of Cu—Cu₂O)=(−338904−32.80256 log T+246.856T)/RT.

This prevents a metal film from being deposited on the exposed region of the ferrite layers in plating the metal film on the external electrode. This allows an electrical connectivity between the external electrode and the helical coil to be good.

According to the laminated coil component and the method for manufacturing it of the present disclosure, these prevent a metal film from being deposited on the ferrite layers of the laminated body and allow an electrical connectivity between the external electrode and the helical coil to be good.

### BRIEF DESCRIPTION OF THE DRAWINGS

FIG. 1 is a cross-sectional view showing an embodiment of the laminated coil component according to the present disclosure.

FIG. 2 is a drawing explaining an embodiment of the method for manufacturing the laminated coil component according to the present disclosure.

FIG. 3 is a drawing explaining the surface resistivity of the exposed region of the ferrite layers.

### DETAILED DESCRIPTION

Hereinafter, this disclosure will be described in detail by way of embodiments thereof shown in the accompanying drawings.

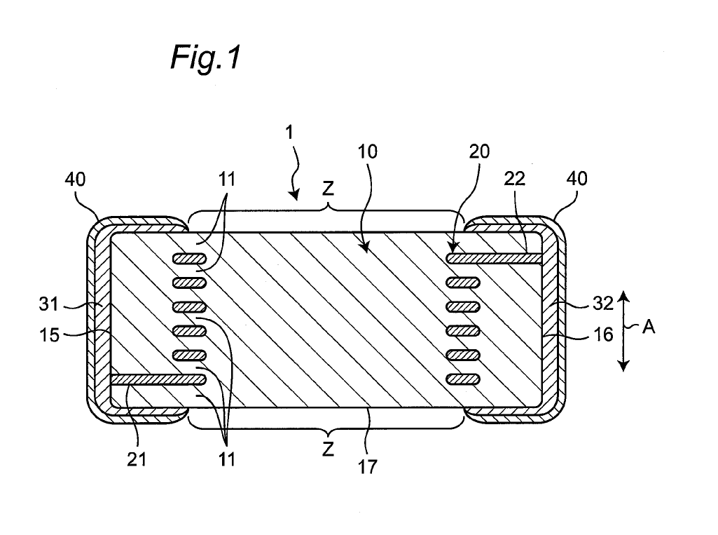

FIG. 1 is a cross-sectional view showing an embodiment of the laminated coil component according to the present disclosure. As shown in FIG. 1, the laminated coil component 1 has a laminated body 10, a helical coil 20 which is provided in the laminated body 10, and a plurality of external electrodes 31 and 32 which are provided on the surface of the laminated body 10 and are electrically connected to the helical coil 20.

The laminated coil component 1 is electrically connected to a wiring of a mounting board (not shown) by the external electrodes 31 and 32. The laminated coil component 1 is used, for example, as a noise removal filter in an electronic device such as a personal computer, a DVD player, a digital camera, a TV, a mobile phone and automotive electronics.

The laminated body 10 is formed by laminating a plurality of ferrite layers 11. The ferrite layers 11 are laminated in a lamination direction A. The ferrite layer 11 is made of a magnetic material and includes at least one of Fe, Mn, Ni and Zn. The ferrite layer 11 is, for example, composed of a compound of Fe₂O₃, ZnO, NiO, CuO and Mn₃O₄.

The laminated body 10 has a substantially rectangular parallelepiped shape. A surface of the laminated body 10 has a first end face 15, a second end face 16 located opposite the first end face 15, and a side face 17 located between the first end face 15 and the second end surface 16. The first end face 15 and the second end face 16, in cross section taken along the lamination direction A, are positioned in a direction orthogonal to the lamination direction A.

The helical coil 20 is, for example, mainly composed of Ag or Cu. When the helical coil 20 is mainly composed of Ag, this allows a direct-current resistance value (Rdc) of the helical coil 20 to be reduced. When the helical coil 20 is mainly composed of Cu, this allows a cost of the helical coil 20 to be reduced.

The helical coil 20 is wound spirally along the lamination direction A. The helical coil 20 has a first leading portion 21 and a second leading portion 22 at both ends. The first leading portion 21 is exposed from the first end face 15 of the laminated body 10, and the second leading portion 22 is exposed from the second end face 16 of the laminated body 10.

The external electrodes 31 and 32 are mainly composed of Cu. When they are mainly composed of Cu, this allows a cost of them to be reduced.

The first external electrode 31 covers all of the first end face 15 of the laminated body 10 and an end portion of the first end face 15 side of the side face 17 of the laminated body 10. The first external electrode 31 is electrically connected in contact with the first leading portion 21.

The second external electrode 32 covers all of the second end face 16 of the laminated body 10 and an end portion of the second end face 16 side of the side face 17 of the laminated body 10. The second external electrode 32 is electrically connected in contact with the second leading portion 22.

On the external electrodes 31 and 32, the metal film 40 is provided. The metal film 40 is composed of, for example, Ni and Sn. When the external electrodes 31 and 32 are bonded to the wiring of the mounting board by soldering, the metal film 40 improves a wettability of a solder. The laminated body 10 is immersed in the plating solution, and the metal film 40 is formed on the external electrodes 31 and 32 by plating.

The ferrite layers 11 have an exposed region Z exposed from the surface of the laminated body 10 without being covered with the external electrodes 31 and 32. The exposed region Z of the ferrite layers 11 is exposed from a part of the side face 17 of the laminated body 10. A surface resistivity of the exposed region Z of the ferrite layers 11 is more than 10⁴Ω and less than 10⁷Ω.

Then the surface resistivity of the exposed region Z of the ferrite layers 11 is more than 10⁴Ω. This prevents the metal film 40 from being deposited on the exposed region Z of the ferrite layers 11, when the laminated body 10 is immersed in the plating solution and the metal film 40 is formed on the external electrodes 31 and 32 by plating.

The surface resistivity of the exposed region Z of the ferrite layers 11 is less than 10⁷Ω. This allows an electrical connectivity between the external electrodes 31 and 32 and the helical coil 20 to be good.

In contrast, when the surface resistivity of the exposed region Z of the ferrite layers 11 is 10⁴Ω or less, the surface resistivity is decreased, so this allows the metal film 40 to be deposited on the exposed region Z of the ferrite layers 11 when the metal film 40 is plated on the external electrodes 31 and 32.

When the surface resistivity of the exposed region Z of the ferrite layers 11 is 10⁷Ω or more, the surface resistivity is increased, so this prevents an electrical connectivity between the helical coil 20 and the external electrodes 31 and 32 from being good.

The ferrite layers 11 include at least one of Fe, Mn, Ni and Zn. This increases a reduction resistance of the ferrite layers 11 to prevent the metal film 40 from being deposited on the ferrite layers 11.

The following describes a method of manufacturing the laminated coil component 1.

A first step is to provide the helical coil 20 in the laminated body 10 which is formed by laminating the ferrite layers 11 so as to be partially exposed from the surface of the laminated body 10.

A second step is to form an unfired external electrode film on the surface of the laminated body 10 by coating an external electrode paste mainly composed of Cu to the surface of the laminated body 10, so that the ferrite layers 11 have the exposed region Z exposed from the surface of the laminated body 10 without being covered with the external electrode paste.

A third step is to form the external electrodes 31 and 32 which are electrically connected to a part of the helical coil 20 and are mainly composed of Cu, by firing the unfired external electrode film.

In the step of forming the unfired external electrode film, an oxygen partial pressure P at 800° C. or more satisfies the following equation:

ln(equilibrium oxygen partial pressure of Cu—Cu₂O)<ln(P)≦ln(4×10⁻¹¹T²−8×10⁻⁸T+5×10⁻⁵),

ln(equilibrium oxygen partial pressure of Cu—Cu₂O)=(−338904−32.80256 log T+246.856T)/RT,

T: temperature[K],
R: gas constant (8.314[J·K⁻¹·mol⁻¹]).

Therefore, according to the laminated coil component 1 manufactured by the method described above, the surface resistivity of the exposed region Z of the ferrite layers 11 is more than 10⁴Ω and less than 10⁷Ω.

When ln(P) is more than ln(equilibrium oxygen partial pressure of Cu—Cu₂O), the surface resistivity of the exposed region Z of the ferrite layers 11 is not less than a predetermined amount (about 10⁴Ω). This prevents the metal film 40 from being deposited on the exposed region Z of the ferrite layers 11, when the laminated body 10 is immersed in the plating solution and the metal film 40 is formed on the external electrodes 31 and 32 by plating.

When ln(P) is ln(4×10⁻¹¹T²−8×10⁻⁸T+5×10⁻⁵) or less, the surface resistivity of the exposed region Z of the ferrite layers 11 is not more than a predetermined amount (about 10⁷Ω). This allows the electrical connectivity between the helical coil 20 and the external electrodes 31 and 32 to be good.

In contrast, when ln(P) is ln(equilibrium oxygen partial pressure of Cu—Cu₂O) or less, the surface resistivity is decreased, so this allows the metal film 40 to be deposited on the exposed region Z of the ferrite layers 11 when the metal film 40 is plated on the external electrodes 31 and 32.

When ln(P) is more than ln(4×10⁻¹¹T²−8×10⁻⁸T+5×10⁻⁵), the surface resistivity is increased, so this prevents an electrical connectivity between the helical coil 20 and the external electrodes 31 and 32 from being good.

### Example

The following describes an example of a method of manufacturing the laminated coil component 1.

### Magnetic Green Sheet

First, a starting material of a magnetic substance was prepared. In a composition of a component of the starting material, Fe₂O₃ is 45 mol %, ZnO is 30 mol %, NiO is 21.5 mol %, CuO is 1 mol %, and Mn₃O₄ is 2.5 mol %. The starting material was put into a pot mill made of vinyl chloride together with deionized water and loosened balls, was thoroughly mixed and crushed while wet, was evaporated to dryness, and was calcined at a temperature of 750° C., so a calcined powder was obtained.

Then, the calcined powder was put into the pot mill made of vinyl chloride again together with polyvinyl butyral-based binder (organic binder), ethanol (organic solvent) and loosened balls, and was thoroughly mixed and crushed, so a ceramic slurry was obtained. By using a doctor blade method, a magnetic green sheet having a thickness of 15 μm was obtained.

### Coil Paste

Metal particles shown in Table 1 were prepared.

TABLE 1

| | | | AVERAGE |
|---|---|---|---|
| | MAIN | | PARTICLE |
| NO. | COMPONENT | SHAPE | SIZE (μm) |
| IM-1 | Cu | SPHERICAL | 1.50 |
| IM-2 | Ag | SPHERICAL | 1.50 |

As shown in Table 1, in No. IM-1, a main component of it was Cu, a shape of it was spherical, and an average particle size of it was 1.50 μm. In No. IM-2, a main component of it was Ag, a shape of it was spherical, and an average particle size of it was 1.50 μm. The average particle size shown in Table 1 was defined by D50 value measured by a laser diffraction method.

An organic vehicle shown in Table 2 was prepared.

TABLE 2

| | COMPOSITION(vol %) | |
|---|---|---|
| NO. | ETHOCEL RESIN | TERPINEOL |
| IV-1 | 12.75 | 87.25 |

As shown in Table 2, in No. IV-1, a composition of Ethocel resin was 12.75 vol %, and a composition of terpineol was 87.25 vol %.

The metal particles shown in Table 1 and the organic vehicle shown in Table 2 were dispersed and mixed by three rolls, so a coil paste shown in Table 3 was obtained.

TABLE 3

| | INORGANIC SOLID | | ORGANIC |
|---|---|---|---|
| | METAL PARTICLE | | VEHICLE |
| NO. | IM-1 | IM-2 | IV-1 |
| IP-1 | 45.0 | — | 55.0 |
| IP-2 | — | 45.0 | 55.0 |

As shown in Table 3, in No. IP-1, No. IM-1 was used as the metal particle was an inorganic solid, No. IV-1 was used as the organic vehicle, a composition of No. IM-1 was 45.0 vol %, and a composition of No. IV-1 was 55.0 vol %. In No. IP-2, No. IM-2 was used as the metal particle was an inorganic solid, No. IV-1 was used as the organic vehicle, a composition of No. IM-2 was 45.0 vol %, and a composition of No. IV-1 was 55.0 vol %.

### External Electrode Paste

Metal particles shown in Table 4 were prepared.

TABLE 4

| | | | AVERAGE |
|---|---|---|---|
| | MAIN | | PARTICLE |
| NO. | COMPONENT | SHAPE | SIZE (μm) |
| EM-1 | Cu | FLAT | 3.00 |
| EM-2 | Cu | SPHERICAL | 1.00 |

As shown in Table 4, in No. EM-1, a main component of it was Cu, a shape of it was flat, and an average particle size of it was 3.00 μm. In No. EM-2, a main component of it was Cu, a shape of it was spherical, and an average particle size of it was 1.50 μm. The average particle size shown in Table 4 was defined by a D50 value measured by a laser diffraction method.

A glass powder shown in Table 5 were prepared.

TABLE 5

| | | AVERAGE | SPECIFIC |
|---|---|---|---|
| | | PARTICLE | SURFACE |
| NO. | MAIN COMPONENT | SIZE (μm) | AREA (m2/g) |
| G-1 | BaO—ZnO—B₂O₃—SiO₂ | 2.5 | 2.8 |

As shown in Table 5, in No. G-1, a main component of it was BaO—ZnO—B₂O₃—SiO₂, an average particle size of it was 2.5 μm, and a specific surface area of it was 2.8m²/g. The average particle size shown in Table 5 was defined by a D50 value measured by a laser diffraction method. The specific surface area (SSA) was a value determined by BET1 point method using nitrogen gas.

An organic vehicle shown in Table 6 were prepared.

TABLE 6

| | COMPOSITION(vol %) | |
|---|---|---|
| | POLYMETHACRYLIC | |
| NO. | ACID ISOBUTYL | TERPINEOL |
| EV-1 | 12.75 | 87.25 |

As shown in Table 6, in No. EV-1, a composition of polymethacrylic acid isobutyl was 12.75 vol %, and a composition of terpineol was 87.25 vol %.

The metal particles shown in Table 4, the glass powder shown in Table 5 and the organic vehicle shown in Table 6 were dispersed and mixed by three rolls, so an external electrode paste shown in Table 7 was obtained.

TABLE 7

| | INORGANIC SOLID | | ORGANIC |
|---|---|---|---|
| | METAL PARTICLE | GLASS | VEHICLE |
| NO. | EM-1 | G-1 | EV-1 |
| EP-1 | 21.0 | 4.0 | 75.0 |

As shown in Table 7, in No. EP-1, No. EM-1 was used as the metal particle being an inorganic solid, and No. G-1 was used as glass being an inorganic solid, No. EV-1 was used as the organic vehicle. A composition of No. EM-1 was 21.0 vol %, a composition of No. G-1 was 4.0 vol %, and a composition of No. EV-1 was 75.0 vol %.

### Manufacturing of Unfired Laminated Body

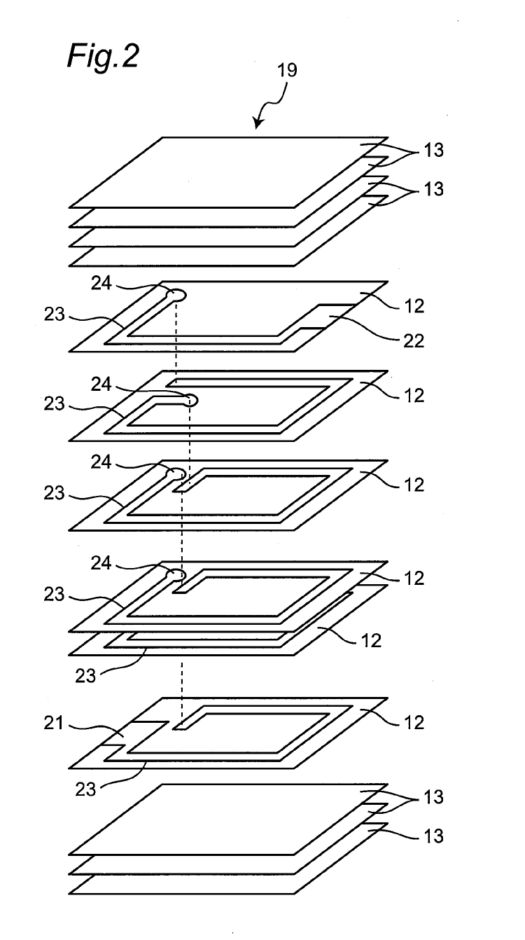

As shown in FIG. 2, the magnetic green sheet was cut into a predetermined size, a plurality of first and second magnetic sheets 12 and 13 were obtained. The first magnetic sheets 12 had via-holes being formed at their predetermined portions by using a laser processing machine, so the first magnetic sheets 12 were able to be electrically connected to each other.

By using screen printing with the coil paste, coil patterns 23 were formed on the first magnetic sheets 12. The via-holes were filled with the coil paste, and via-hole conductors 24 were formed. On the second magnetic sheets 13, coil patterns 23 were not formed.

The coil pattern 23 formed on the first magnetic sheet 12 on the lower side, had a first leading portion 21 to be electrically connected to the first external electrode 31. The coil pattern 23 formed on the first magnetic sheet 12 on the upper side had a second leading portion 22 to be electrically connected to the second external electrode 32.

Then, the first magnetic sheets 12 having formed coil patterns 23 were laminated, and the first magnetic sheets 12 were sandwiched by the second magnetic sheets 13 not having a coil pattern 23. The laminated first and second magnetic sheets 12 and 13 were pressed, and each coil pattern 23 was connected through via-hole conductors 24. Connected coil patterns 23 constituted a helical coil 20. Thus, an unfired laminated body 19 was manufactured. Specifically an unfired laminated body shown in Table 8 was obtained.

TABLE 8

| | COIL PASTE | |
|---|---|---|
| NO. | IP-1 | IP-2 |
| RS-1 | ○ | — |
| RS-2 | — | ○ |

As shown in Table 8, in No. RS-1, No. IP-1 was used as the coil paste, and No. IP-2 was used as the coil paste.

The unfired laminated body was cut in the lamination direction, so each chip of laminated coil component was obtained. Herein, the size of the chip was 2.0 mm (L: length)×1.6 mm (W: width)×1.0 mm (T: thickness), and the chip had a rectangular shape in a plan view.

### Firing of Unfired Laminated Body

The unfired laminated body was fired under conditions shown in Table 9.

TABLE 9

| | UNFIRED | | MAXIMUM |
|---|---|---|---|
| | LAMINATED | | TEMPERATURE |
| NO. | BODY | ATMOSPHERE IN FIRING | (° C.) |
| S-1 | RS-1 | EQUILIBRIUM OXYGEN | 975 |
| | | PARTIAL PRESSURE OF | |
| | | Cu—Cu₂O OR LESS | |
| S-2 | RS-2 | AIR | 890 |

As shown in Table 9, in No. S-1, No. RS-1 was used as the unfired laminated body, and the unfired laminated body was fired at a maximum temperature of 975° C. in an atmosphere of an equilibrium oxygen partial pressure of Cu—Cu₂O or less, so a laminated body was obtained. In No. S-2, No. RS-2 was used as the unfired laminated body, the unfired laminated body was fired at a maximum temperature of 890° C. in air atmosphere, so a laminated body was obtained.

### Forming of Unfired External Electrode Film

The external electrode paste was immersed and coated to the laminated body to cover the first and the second leading portions of the helical coil, so an unfired external electrode film was formed.

### Firing of Unfired External Electrode Film

The laminated body providing the unfired external electrode film was degreased at 400° C. in N₂ atmosphere, then was heated up to 890° C. at a heating rate of 80° C./min by using a tunnel furnace, and then was lowered to room temperature at a rate of 80° C./min, so a laminated coil component was obtained.

When the unfired external electrode film was fired, the oxygen partial pressure in a temperature range of 800° C. or more, such as the oxygen partial pressure shown in Table 10, was controlled by the N₂/H₂O/H₂/air. In the temperature range of less than 800° C., in N₂ atmosphere, the unfired external electrode film was fired.

TABLE 10

| | | | OXYGEN PARTIAL |
|---|---|---|---|
| | EXAMPLE | LAMINATED | PRESSURE AT |
| | NO. | BODY NO. | 800° C. (atm) |
| | 1 | S-1 | 2.0E−09 |
| | 2 | S-1 | 9.2E−07 |
| | 3 | S-1 | 8.8E−06 |
| | 4 | S-1 | 7.6E−11 |
| | 5 | S-1 | 1.7E−04 |
| | 6 | S-2 | 2.0E−09 |
| | 7 | S-2 | 9.2E−07 |
| | 8 | S-2 | 8.8E−06 |
| | 9 | S-2 | 7.6E−11 |
| | 10 | S-2 | 1.7E−04 |

 OUTSIDE THE SCOPE OF THE INVENTION

As shown in Table 10, in Example No. 1, the laminated body of No. S-1 was used, and the oxygen partial pressure at 800° C. was 2.0E-09 atm. In Example No. 2, the laminated body of No. S-1 was used, and the oxygen partial pressure at 800° C. was 9.2E-07 atm. In Example No. 3, the laminated body of No. S-1 was used, and the oxygen partial pressure at 800° C. was 8.8E-06 atm. In Example No. 4, a laminated body of No. S-1 was used, and the oxygen partial pressure at 800° C. was 7.6E-11 atm. In Example No. 5, the laminated body of No. S-1 was used, and the oxygen partial pressure at 800° C. was 1.7E-04 atm. In Example No. 6, the laminated body of No. S-2 was used, and the oxygen partial pressure at 800° C. was 2.0E-09 atm. In Example No. 7, the laminated body of No. S-2 was used, and the oxygen partial pressure at 800° C. was 9.2E-07 atm. In Example No. 8, the laminated body of No. S-2 was used, and the oxygen partial pressure at 800° C. was 8.8E-06 atm. In Example No. 9, the laminated body of No. S-2 was used, and the oxygen partial pressure at 800° C. was 7.6E-11 atm. In Example No. 10, the laminated body of No. S-2 was used, and the oxygen partial pressure at 800° C. was a 1.7E-04 atm. At this time, the equilibrium oxygen partial pressure of Cu—Cu₂O was 1.6E-09 atm.

In Example No. 1-3 and 6-8, the oxygen partial pressure P at 800° C. or more satisfied the following equation:

ln(equilibrium oxygen partial pressure of Cu—Cu₂O)<ln(P)≦ln(4×10⁻¹¹T²−8×10⁻⁸T+5×10⁻⁵).

The oxygen partial pressure P was within the scope of the disclosure.

As shown in “” in Table 10, in Example Nos. 4, 5, 9 and 10, the oxygen partial pressure P at 800° C. or more did not satisfy the following equation:

ln(equilibrium oxygen partial pressure of Cu—Cu₂O)<ln(P)≦ln(4×10⁻¹¹T²−8×10⁻⁸T+5×10⁻⁵).

The oxygen partial pressure P was outside the scope of the disclosure. In Example Nos. 4 and 9, ln(P) was ln(equilibrium oxygen partial pressure of Cu—Cu₂O) or less. In Example Nos. 5 and 10, ln(P) was more than ln(4×10⁻¹¹T²−8×10⁻⁸T+5×10⁻⁵).

### Characterization of Laminated Coil Component

With respect to the laminated coil component of Example Nos. 1-10, the Characterization of the following (i), (ii), and (iii) was obtained.

### (i) Surface Resistivity of Laminated Coil Component

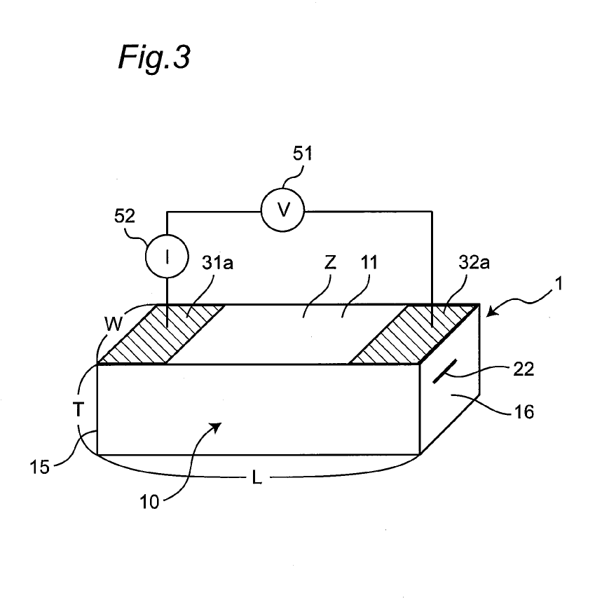

FIG. 3 is an explanatory drawing explaining the surface resistivity of the exposed region Z of the ferrite layers 11. As shown in FIG. 3, after firing the unfired external electrode film, the external electrodes of the LT and WT face of the laminated coil component 1 were polished, and as shown by hatching in FIG. 3, in each of the WT face, in both ends of the LW plane, part of the external electrodes 31a and 32a was left.

The L direction refers to a direction connecting the first end face 15 and the second end face 16 in the laminated body 10, the T direction refers to the laminating direction of the ferrite layers 11, and the W direction refers to a direction perpendicular to the L direction and the T direction.

Parts 31a and 32a of the external electrodes were connected to a voltmeter 51 and an ammeter 52. The voltage of 5V was applied between parts 31a and 32a. The surface resistivity of the exposed region Z of the ferrite layers 11 of the laminated body 10 was measured by the two-terminal method. This operation was performed with respect to 30 pieces of the laminated coil component 1, and the average value was calculated.

### (ii) Connectivity Between Helical Coil and External Electrode

Referring to FIG. 1, The voltage of 5V was applied between the external electrodes 31a and 32a. A resistance value was measured between the external electrodes 31a and 32a. This operation was performed with respect to 30 pieces of the laminated coil component 1. In all 30 laminated coil components 1, in which the resistance value was less than 1Ω, it was determined that there was no problem in the electrical connection of the helical coil 20 and the external electrodes 31 and 32.

(iii) Abnormal Deposition in Plating on the Surface of the Laminated Coil Component

Referring to FIG. 1, an electrolytic Ni plating was performed on the laminated body 10 and the external electrodes 31 and 32. The surface of the laminated body 10 after Ni-plating was observed with a magnifying glass (10 times). In the two sides of the LW face and the two sides of the LT face, 30 laminated coil components 1 were observed. In all 30 laminated coil components 1, in which Ni extending on the surface of the laminate 10 from the external electrodes 31 and 32 was 100 μm or less, it was determined that there was no problem without an abnormal deposition in plating.

The result of the Characterization of the above-mentioned (i), (ii), and (iii) was shown in Table 11.

TABLE 11

| | | | SURFACE | CONNECTIVITY | ABNORMAL DEPOSITION IN |
|---|---|---|---|---|---|
| | | | RESISTIVITY OF | BETWEEN HELICAL | PLATING ON THE SURFACE |
| | SAMPLE | LAMINATED | LAMINATED COIL | COIL AND EXTERNAL | OF THE LAMINATED |
| | NO. | BODY NO. | COMPONENT(Ω) | ELECTRODE | COIL COMPONENT |
| | 1 | S-1 | 9.8E+05 | ∘ | ∘ |
| | 2 | S-1 | 4.6E+06 | ∘ | ∘ |
| | 3 | S-1 | 8.6E+06 | ∘ | ∘ |
| | 4 | S-1 | 2.3E+04 | ∘ | x |
| | 5 | S-1 | 4.7E+07 | x | ∘ |
| | 6 | S-2 | 5.3E+06 | ∘ | ∘ |
| | 7 | S-2 | 9.1E+06 | ∘ | ∘ |
| | 8 | S-2 | 2.9E+07 | ∘ | ∘ |
| | 9 | S-2 | 4.9E+04 | ∘ | x |
| | 10 | S-2 | 2.7E+08 | x | ∘ |

 OUTSIDE THE SCOPE OF THE INVENTION

As shown in Table 11, the laminated coil components shown in Example Nos. 1-3 and 6-8 within the scope of the disclosure, had no problem with the electrical connection of the helical coil and the external electrodes, without an abnormal deposition in plating. In this case, the surface resistivity of the exposed region of the ferrite layers is more than 10⁴Ω and less than 10⁷Ω.

In contrast, as shown by a mark “” in Table 11, the laminated coil components shown in Example Nos. 4 and 9 were fired at a lower oxygen partial pressure than the oxygen partial pressure indicated in the disclosure, so an abnormal deposition in plating occurred. In this case, the surface resistivity of the exposed region of the ferrite layers was 10⁴Ω or less.

As shown by a mark “” in Table 11, the laminated coil components shown in Example Nos. 5 and 10 were fired at a higher oxygen partial pressure than the oxygen partial pressure indicated in the disclosure, so copper included in the external electrode was oxidized, and the problem occurred in the electrical connection of the helical coil and the external electrodes. In this case, the surface resistivity of the exposed region of the ferrite layers was 10⁷Ω or more.

The present disclosure is not limited to the above embodiments, and various modifications and changes can be made to those embodiments without departing from the scope of the present disclosure.

Although in the embodiment the laminated body is constituted of a ferrite layer made of a magnetic material, it may include, other than a ferrite layer, a non-magnetic layer made of a nonmagnetic material.

Although in the embodiment the exposed region of the ferrite layers of the laminated body is exposed to the outside of the laminated coil component, it may be covered by a coating layer such as a glass material.

What is claimed is:

1. A laminated coil component comprising:
a laminated body formed by a plurality of laminated ferrite layers;
a helical coil provided in the laminated body so as to be partially exposed from a surface of the laminated body; and
a plurality of external electrodes provided on the surface of the laminated body and electrically connected to a part of the helical coil and being mainly composed of one of Cu and Ag,
wherein:
the ferrite layers have an exposed region exposed from the surface of the laminated body without being covered by the external electrodes,
a surface resistivity of the exposed region of the ferrite layers is more than 10⁴Ω and less than 10⁷Ω.

2. The laminated coil component according to claim 1, wherein
the helical coil is mainly composed of Ag.

3. The laminated coil component according to claim 1, wherein
the helical coil is mainly composed of Cu.

4. The laminated coil component according to claim 1, wherein
the ferrite layers include at least one of Fe, Mn, Ni and Zn.

5. A method for manufacturing a laminated coil component comprising:
providing a helical coil in a laminated body which is formed by laminating a plurality of ferrite layers so as to be partially exposed from a surface of the laminated body;
forming an unfired external electrode film on the surface of the laminated body by coating an external electrode paste mainly composed of Cu to the surface of the laminated body, so that the ferrite layers have a region exposed from the surface of the laminated body without being covered with the external electrode paste; and
forming a plurality of external electrodes which are electrically connected to a part of the helical coil and are mainly composed of Cu, by firing the unfired external electrode film,
wherein:
in the forming of the unfired external electrode film,
an oxygen partial pressure P at 800° C. or more satisfies the following equation:
ln(equilibrium oxygen partial pressure of Cu—Cu₂O)<ln(P)≦ln(4×10⁻¹¹T²−8×10⁻⁸T+5×10⁻⁵),
ln(equilibrium oxygen partial pressure of Cu—Cu₂O)=(−338904−32.80256 log T+246.856T)/RT,
T: temperature [K], and
R: gas constant (8.314 [J·K⁻¹·mol⁻¹]).
